(19) United States
(12) Patent Application Publication
(10) Pub. No.: US 2020/0255270 A1
(43) Pub. Date: Aug. 13, 2020

(54) TURNING STAND

(71) Applicant: MTU Aero Engines AG, Munich (DE)

(72) Inventors: Florian CEROVSKY, Garmisch-Partenkirchen (DE); Stefan HOFNER, Hettenshausen (DE); Gianfranco ZAMPINO, Dachau (DE)

(21) Appl. No.: 16/787,047

(22) Filed: Feb. 11, 2020

(30) Foreign Application Priority Data
Feb. 12, 2019 (DE) 102019201797.5

(51) Int. Cl. B66F 7/14; B64F 5/50; B66F 7/28

(52) U.S. Cl. CPC B66F 7/14; B66F 7/28; B64F 5/50

(57) ABSTRACT

A turning stand for handling components includes a first lifting column, a first swivel flange arranged on the first lifting column, a first lift actuator configured to adjust a height of the first swivel flange along a first lifting axis, and a first swivel actuator configured to swivel the first swivel flange about a first swivel axis. The turning stand further includes a supply device associated with the first lifting column, the supply device comprising at least one rechargeable storage device, fixed to the turning stand, configured to supply the first lift actuator and/or the first swivel actuator with electrical energy.

### CROSS REFERENCE TO RELATED APPLICATIONS

This application claims benefit to German Patent Application No. DE 10 2019 201 797.5, filed Feb. 12, 2019, which is incorporated by reference herein.

### FIELD

The present invention relates to a turning stand for handling, in particular at least partially mounting, dismounting, servicing and/or inspecting, components, in particular of an aircraft engine, to a turning stand module arrangement and to a method for producing various turning stands, and to a method for handling, in particular at least partially mounting, dismounting, servicing and/or inspecting, a component, in particular of an aircraft engine, by means of a turning stand.

### BACKGROUND

From in-house practice, turning stands for mounting, dismounting, servicing and inspecting aircraft engine components are known, with which the components are arranged at a vertical height and in an (angular) position about a horizontal axis which are advantageous for this purpose.

### SUMMARY

In an embodiment, the present invention provides a turning stand for handling components. The turning stand includes a first lifting column, a first swivel flange arranged on the first lifting column, a first lift actuator configured to adjust a height of the first swivel flange along a first lifting axis, and a first swivel actuator configured to swivel the first swivel flange about a first swivel axis. The turning stand further includes a supply device associated with the first lifting column, the supply device comprising at least one rechargeable storage device, fixed to the turning stand, configured to supply the first lift actuator and/or the first swivel actuator with electrical energy.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a turning stand according to one embodiment;

FIGS. 2A-2E illustrate turning stands according to further embodiments;

FIG. 3 illustrates a method for producing various turning stands according to one embodiment; and

FIG. 4 illustrates a method for handling a component by means of one of the turning stands according to one embodiment of the present invention.

### DETAILED DESCRIPTION

The present disclosure describes embodiments that provide for an improvement in the handling of components by means of turning stands or the turning stands or their production.

Embodiments described herein include a turning stand, a turning stand module arrangement, and a method for producing various turning stands.

According to an embodiment, a turning stand is provided, in particular configured or used, for handling (e.g. for at least partially mounting, dismounting, servicing and/or inspecting) components (e.g. components of an aircraft engine). The turning stand comprises a first lifting column with a first swivel flange, a first lift actuator by means of which a height of the first swivel flange is or can be adjusted along a first lifting axis or which is configured or used for this purpose, and a first swivel actuator by means of which the first swivel flange is or can be swiveled about a first swivel axis or which is configured or used for this purpose, and a storage arrangement which is fixed to the turning stand and has at least one rechargeable storage device for supplying the first lift actuator and/or the first swivel actuator with electrical energy. Accordingly, the first lift actuator and/or the first swivel actuator in one embodiment is an electric actuator, which in one development has at least one electric motor.

According to an embodiment, a turning stand module arrangement for producing turning stands has one or more structurally identical or structurally different first lifting column(s) with a first swivel flange (each), a first lift actuator (each) by means of which a height of the (respective) first swivel flange is or can be adjusted along a first lifting axis or which is configured or used for this purpose, and a first swivel actuator (each) by means of which the (respective) first swivel flange is or can be swiveled about a first swivel axis or which is configured or used for this purpose, and a storage arrangement (each) which is fixed to the turning stand and has at least one rechargeable storage device (each) for supplying the (respective) first lift actuator and/or first swivel actuator with electrical energy. Accordingly, the first lift actuator and/or the first swivel actuator in one embodiment is (in each case) an electric actuator which in one development has at least one electric motor.

By means of an electrical swivel actuator or lift actuator, the adjustment or swiveling can be improved, in particular its speed and/or precision can be increased, in one embodiment.

In one embodiment, an impairment by cables connected to a power grid can advantageously be avoided by an electrical energy supply using rechargeable storage devices, in particular accumulators, which are fixed to the turning stand. This applies in particular to stationary turning stands. Accordingly, the turning stand in one embodiment is a stationary or fixed (erected) turning stand.

Likewise, the turning stand in one embodiment can advantageously be used or operated at various locations as a result of an electrical energy supply by means of rechargeable storage devices fixed to the turning table. Accordingly, the turning stand in one embodiment is a mobile turning stand, which in one development has a carriage with drive-less and/or drive wheels.

In one embodiment, at least one of the first lifting columns of the turning stand module arrangement is a lifting column which is provided, in particular configured or used, for stationary or fixed (erected) operation. Additionally or alternatively, at least one of the first lifting columns of the turning stand module arrangement in one embodiment is a mobile lifting column, which in one embodiment has a carriage, in particular one or more passive and/or one or more driven rollers. In this way, both stationary and also mobile turning stands can be produced by means of the turning stand module arrangement in one embodiment.

In one embodiment, the components can have a weight of at least 50 kg, in particular at least 100 kg, in one embodiment at least 500 kg, and/or at most 10000 kg, in particular at most 5000 kg, in one embodiment at most 2500 kg. Based on their weight, the turning stand can be used for handling such components with particular advantage in one embodiment.

In one embodiment, the first lifting axis and the first swivel axis form an angle which is at least 60° and/or at most 120°; in one development, they are perpendicular to one another. Additionally or alternatively, the first lifting axis in one embodiment is vertical and/or the first swivel axis in one embodiment is horizontal. As a result, the components in one embodiment can be positioned particularly advantageously, in particular in an ergonomically favorable manner.

In one embodiment, the turning stand has a further lifting column with a further swivel flange which can be swiveled about a swivel axis which is in particular parallel to the first swivel axis, in one embodiment aligned or identical thereto, and a further lift actuator for adjusting a height of the further swivel flange along a further lifting axis which is parallel to, in particular offset in parallel to or horizontally spaced apart from, the first lifting axis in one embodiment.

In this case, the turning stand in one embodiment has a further swivel actuator for swiveling the further swivel flange about said swivel axis, which in particular is parallel to the first swivel axis, in one embodiment aligned or identical thereto. In an alternative embodiment, the further swivel flange can also be passive or without a self-actuator or can be used in such a way.

In this case, precision and/or load distribution can advantageously be improved by means of a further swivel actuator for actively swiveling the further swivel flange, and the further lifting column can be simpler, in particular lighter, or can be designed in such a way by means of a passive (swivelable) further swivel flange.

Additionally or alternatively, the storage arrangement in one embodiment is configured or used for (also) supplying the further lift actuator and/or, if present, the further swivel actuator with electrical energy; in one development, the same rechargeable storage device is configured or used for supplying the first and further lift actuators and/or for supplying the first and, if present, the further swivel actuator with electrical energy.

Additionally or alternatively, the first and further lifting columns in one embodiment are connected to one another by one or more bottom-side and/or immovable carriers which are spaced apart, in particular vertically spaced apart, from the first and/or further swivel flange in one embodiment, the connection taking place rigidly or firmly in one embodiment, permanently or non-destructively detachably, in particular by firm bonding, in one embodiment, by welding, soldering and/or adhesive bonding, in one embodiment, non-destructively detachably, in particular positively and/or frictionally, in another embodiment, by screws or the like in one embodiment. In one embodiment, the turning stand is thus U-shaped or U-like, the first and further lifting columns forming the legs and the bottom-side carrier(s) forming the base of the U.

In one embodiment, a component receptacle is fastened to the first swivel flange and/or to the further swivel flange, non-destructively detachably, in particular positively and/or frictionally, in one development, by screws or the like in one embodiment. In one embodiment, the component receptacle is provided, in particular configured or used, for the non-destructively detachable fastening, in particular clamping and/or screwing, in one embodiment the frictional and/or positive fastening, of the component.

As a result, in one embodiment, in particular heavier components can respectively be advantageously mounted, in particular supported, in particular in a combination of two or more of the aforementioned embodiments.

In one embodiment, the turning stand module arrangement has two or more different further lifting columns of the ones described herein and/or two or more different component receptacles. Additionally or alternatively, the turning stand module arrangement has at least two different carriers in one embodiment.

In order to produce various turning stands, at least one of the first lifting columns described herein is then connected in one embodiment to a component receptacle and/or further lifting column, and at least one other of the first lifting columns described herein, in particular in a manner structurally identical to said first lifting column, is connected to a component receptacle different from said component receptacle and/or to a further lifting column different from said further lifting column. Additionally or alternatively, in order to produce various turning stands, at least one of the first lifting columns described herein is connected in one embodiment to a further lifting column by means of a carrier and at least one other of the first lifting columns described herein, in particular in a manner structurally identical to said first lifting column, is connected to a further lifting column by means of a carrier different from said carrier.

In one embodiment, at least one of the first lifting columns described herein is connected (only) to a component receptacle and not to a further lifting column, and at least one, in particular structurally identical, other of the first lifting columns described herein is connected to a component receptacle and to a further lifting column which is also connected to said component receptacle. Additionally or alternatively, in one embodiment, at least one of the first lifting columns described herein is connected to a component receptacle and at least one, in particular structurally identical, other of the first lifting columns described herein is connected to a different component receptacle.

As a result, in one embodiment, different turning stands can be produced modularly and the production thereof can thereby be improved in one embodiment, in particular a time and/or number of different semi-finished products required for this purpose can be reduced.

In one embodiment, the first lift actuator is control-electrically coupled to the further lift actuator, in particular (electrically) synchronized, and/or the first lift actuator is mechanically decoupled from the further lift actuator.

Additionally or alternatively, in one embodiment, the first swivel actuator is control-electrically coupled to the further swivel actuator, in particular (electrically) synchronized, and/or the first swivel actuator is mechanically decoupled from the further swivel actuator.

Additionally or alternatively, in one embodiment, the first lift actuator is control-electrically coupled to the first swivel actuator, in particular such that a height is adjusted, optionally automatically, when a predetermined swivel position is reached and/or a swivel position is adjusted, optionally automatically, when a predetermined height is reached, in particular in order to avoid interference, in particular collision, with the bottom or a bottom-side carrier, and/or to mechanically decouple the first lift actuator from the first swivel actuator.

Additionally or alternatively, in one embodiment, the further lift actuator is control-electrically coupled to the first and/or the further swivel actuator, in particular such that a height is adjusted, optionally automatically, when a predetermined swivel position is reached and/or a swivel position is adjusted, optionally automatically, when a predetermined height is reached, in particular in order to avoid interference, in particular collision, with the bottom or a bottom-side carrier, and/or to mechanically decouple the further lift actuator from the further swivel actuator.

Accordingly, in one embodiment, the turning stand has a control which controls the first lift actuator and/or further lift actuator, in particular synchronizes them with each other, and/or controls the first swivel actuator and/or the further swivel actuator, in particular synchronizes them with each other, and/or controls the first or further lift and swivel actuators such that a height is adjusted, optionally automatically, when a predetermined swivel position is reached and/or a swivel position is adjusted, optionally automatically, when a predetermined height is reached, in particular in order to avoid interference, in particular collision, with the bottom or a bottom-side carrier, or which is configured for this purpose, in particular in terms of hardware and/or software, in particular in terms of program technology. In one embodiment, the control has an input device, which is fixed to the turning stand in one embodiment, in particular one or more switches, control panel(s) or the like, for, in particular manually, inputting (nominal) heights (adjustments) and/or swivel positions (changes).

By means of said mechanical decoupling and/or (only) control-electrical coupling, friction losses can be reduced, the construction-like production of different turning stands can be simplified and/or the condition and/or precision can be improved in one embodiment.

In one embodiment, the storage arrangement has two or more rechargeable storage devices which are (in each case) configured or used for supplying the first and/or further lift actuators and/or the first and/or further swivel actuators with electrical energy. In one embodiment, the at least two storage devices are alternatively used or utilized for supplying power to the actuator(s), in particular switching takes place from one storage device to the other storage device (for this purpose) as soon as (it is detected that) the one storage device has a predetermined charge state, the detection in one embodiment taking place automatically, in particular by the control, or the turning stand, in particular the control and/or storage arrangement, is configured for this purpose in particular in terms of hardware and/or software, in particular in terms of program technology.

Additionally or alternatively, the or one or more of the storage devices of the storage arrangement fixed to the turning stand is/are (in each case) non-destructively detachably arranged on the turning stand, in one embodiment on its first or its further lifting column, in particular at least partially inserted thereinto.

Additionally or alternatively, the at least two storage devices of the storage arrangement fixed to the turning stand are arranged together or at the same time on the turning stand, in one embodiment on its first or its further lifting column, in particular at least partially inserted thereinto.

In one embodiment, in particular in a combination of two or more of the aforementioned embodiments, the energy supply can thereby respectively be improved, in particular prolonged and/or reliably ensured.

In one embodiment, the first lifting column has a rail guide and/or a ball screw or a ball-type linear drive, in particular a rolling screw drive with balls as rolling bodies, for converting a rotational movement into a longitudinal movement, for adjusting a height of the first swivel flange along the first lifting axis.

Additionally or alternatively, in one embodiment, the further lifting column has a rail guide and/or a ball screw or a ball-type linear drive, in particular a rolling screw drive with balls as rolling bodies, for converting a rotational movement into a longitudinal movement, for adjusting a height of the further swivel flange along the further lifting axis.

In one embodiment, this makes it possible to increase precision and/or load capacity and/or to reduce friction.

In one embodiment, the first swivel actuator has an angular gear, in particular an angular servo gear and/or bevel gear, for swiveling the first swivel flange about the first swivel axis. Additionally or alternatively, in one embodiment, the further swivel actuator has an angular gear, in particular an angular servo gear and/or bevel gear, for swiveling the further swivel flange about its swivel axis.

As a result, in one embodiment, swiveling can be carried out (more) quickly, (more) precisely, (more) efficiently, in particular with high efficiency, and/or with high torque. In one embodiment, the component receptacle is fastened, in particular directly, to a gear flange of the angular gear of the first and/or the further swivel actuator, so that additional mounting in one embodiment can advantageously be dispensed with. Accordingly, a gear flange or output flange of the (respective) angular gear can form the first or the further swivel flange.

According to one embodiment, a method comprises the step of:
mounting the (respective) component, in particular by means of a or the component receptacle, on the first swivel flange and optionally on the further swivel flange, in one embodiment by means of fastening, in particular non-destructively detachably fastening, in one embodiment frictionally and/or positively fastening, in particular clamping and/or screwing, the component to the component receptacle;
   at least one of the steps of:
adjusting the height of the component mounted on the first swivel flange and optionally on the further swivel flange, in particular by means of the component receptacle, along the first lifting axis by means of the first lift actuator and optionally by means of the further lift actuator; and/or
swiveling the component mounted on the first swivel flange and optionally on the further swivel flange, in particular by means of the component receptacle, about the first swivel axis by means of the first swivel actuator and optionally by means of the further swivel actuator;
   and at least one of the steps of:
handling, in particular at least partially mounting, dismounting, servicing and/or inspecting the component mounted on the first swivel flange in or during said adjustment or swiveling; and/or
handling, in particular at least partially mounting, dismounting, servicing and/or inspecting the component mounted on the first swivel flange after said adjustment or swiveling.

In one embodiment, the turning stand is used or configured for this purpose.

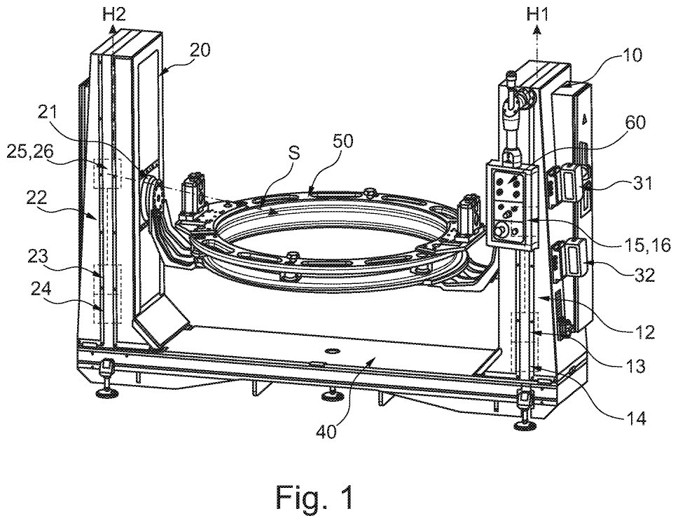

FIG. 1 shows a turning stand according to one embodiment.

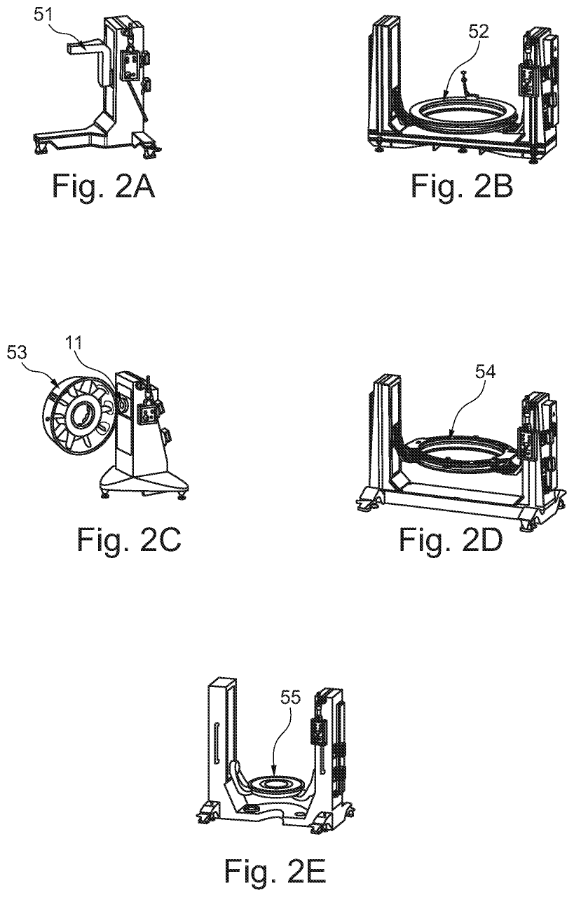

This turning stand has a first lifting column 10 with a first swivel flange 11 (concealed in FIG. 1; cf. FIG. 2C), a rail guide 12 and a ball screw 13, and an electrical first lift actuator 14, which are arranged in the interior of the turning stand and are therefore indicated only by dashed lines, for adjusting a height of the first swivel flange along a first vertical lifting axis H1.

A first electrical swivel actuator 15 has an angular gear 16 for swiveling the first swivel flange about a horizontal first swivel axis S and is likewise arranged in the interior of the turning stand and is therefore indicated only by dashed lines.

The turning stand has a further lifting column 20 with a further swivel flange 21, a rail guide 22 and a ball screw 23, and an electrical further lift actuator 24, which are arranged in the interior of the turning stand and are therefore indicated only by dashed lines, for adjusting a height of the further swivel flange along a further vertical lifting axis H2.

Another electrical swivel actuator 25 has an angular gear 26 for swiveling the further swivel flange about a horizontal swivel axis S identical to the first swivel axis and is likewise arranged in the interior of the turning stand and is therefore indicated only by dashed lines. In one modification, further swivel actuator 25 and angular gear 26 can also be omitted and the further swivel flange 21 can (simultaneously) be swiveled passively about the swivel axis S.

The turning stand further comprises a storage arrangement which is fixed to the turning stand and has two rechargeable storage devices 31, 32 for alternatively supplying electrical energy to the first and further lift actuators 14, 24 and the first and further swivel actuators 15, 25.

The first and further lifting columns 10, 20 are connected to one another by a bottom-side carrier 40 which is vertically spaced apart from the swivel flanges and through which cables for energy supply are also guided from the storage devices 31, 32 to the actuators 24, 25.

A component receptacle 50 for receiving an FDC module of an aircraft engine is fastened to the two swivel flanges.

The two lift actuators 14, 24, swivel actuator 15 and optionally swivel actuator 25 are all mechanically decoupled from one another.

The turning stand has a control which has an operating panel 60 and controls the lift and swivel actuators 14, 15, 24, 25.

In doing so, it controls the two lift actuators 14, 24 in such a way that they move synchronously. The two swivel actuators 15, 25 are also coupled electrically by the control (control-electrically coupled) in this way.

FIG. 4 shows a method for handling the FDC module (not shown) by means of the turning stand according to one embodiment.

In a first step S100, the FDC module is non-destructively detachably fastened to the component receptacle 50.

In a step S200, the control then moves the two lift actuators 14, 24 and/or the two swivel actuators 15, 25 synchronously in each case in accordance with a manual operation of the operating panel in order to position the swivel flanges and thus the component receptacle 50 fastened thereto and the FDC module fastened to said component receptacle at a desired, in particular in an ergonomically favorable manner, vertical height and orientation about the swivel axis S.

If the swivel flanges in a position close to the bottom in this case approach a swivel position, in which the component receptacle 50 or the FDC module fastened thereto could collide with the carrier 40, the control correspondingly moves the swivel flanges vertically upward by controlling the two lift actuators 14, 24, which in this respect are control-electrically coupled to the two swivel actuators 15, 25.

At the desired height and orientation, the FDC module is then at least partially mounted, dismounted, serviced and/or inspected (S300).

FIGS. 2A-2E show turning stands according to further embodiments in a view corresponding to that of FIG. 1.

The turning stands of the embodiments of FIGS. 2B, 2E have component receptacles 52 or 55 for receiving a TCF module (FIG. 2B) or LPT/TEC module (FIG. 2E) of an aircraft engine, and the turning stand of the embodiment of FIG. 2D has a different component receptacle 54 for receiving a TCF module of an aircraft engine.

The otherwise structurally identical and analogously used turning stands of FIGS. 1 and 2B are stationary, but their lifting columns are connected by different carriers. The turning stands of FIGS. 2D and 2E which are otherwise structurally identical thereto and used analogously thereto can be rolled, their lifting columns being connected by different carriers.

The turning stands of FIGS. 2A, 2C have only a first lifting column, on the first swivel flange 11 of which a component receptacle 51 for an MGB module (FIG. 2A) or a component receptacle 53 for a TEC module (FIG. 2C) is fastened, the lifting columns being substantially identical and being used analogously to the first lifting column of FIG. 1.

The turning stand of FIG. 2C is again stationary, and the turning stand of FIG. 2A can be rolled.

As already explained with reference to FIG. 1, a further swivel actuator 25 for swiveling the further swivel flange 21 of the further lifting column can also be provided in each case in the turning stands of FIGS. 2B, 2D and 2E, or said further swivel flange 21 can also be passive or without a self-actuator.

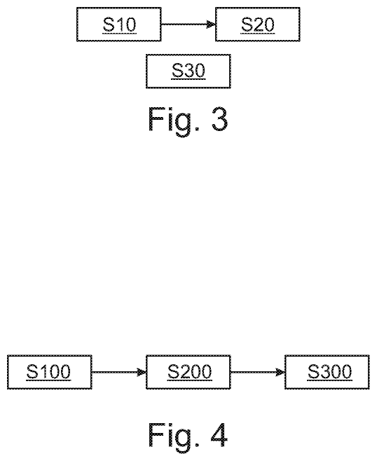

In order to produce the various turning stands, a first lifting column is on the one hand connected, as indicated in FIG. 3, to a further lifting column (FIG. 3: step S10) and the corresponding component receptacle is fastened to the swivel flanges thereof (S20). In this way, the turning stands of FIGS. 1, 2B, 2D and 2E can in particular be produced.

In parallel or offset in time thereto, only the corresponding component receptacle is fastened in a step S30 to a first lifting column or its swivel flange, without the lifting column being connected to a further lifting column. In this way, the turning stands of FIGS. 2A and 2C can in particular be produced.

Although exemplary embodiments were illustrated in the foregoing description, it is pointed out that a plurality of modifications is possible.

For example, two different turning stands, as explained with reference to FIG. 1, can be produced by connecting, in particular for higher loads, a first lifting column 10 to a further lifting column 20 with a further electric swivel actuator 25 and angular gear 26 for swiveling the further swivel flange 21 and, in particular for lower loads, a structurally identical first lifting column 10 to a further lifting column 20 without a further electrical swivel actuator 25 and angular gear 26 whose further swivel flange 21 is (simultaneously) swiveled passively about the swivel axis S.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

10 First lifting column
11 First swivel flange
12 Rail guide
13 Ball screw
14 First lift actuator
15 First swivel actuator
16 Angular gear
20 Further lifting column
21 Further swivel flange
22 Rail guide
23 Ball screw
24 Further lift actuator
25 Further swivel actuator
26 Angular gear
31,32 Supply device/storage (arrangement)
40 Carrier
50-55 Component receptacle
60 Control with operating panel
H1 First lifting axis
H2 Further lifting axis
S (First) swivel axis

1. A turning stand for handling components, the turning stand comprising
a first lifting column;
a first swivel flange arranged on the first lifting column;
a first lift actuator configured to adjust a height of the first swivel flange along a first lifting axis;
a first swivel actuator configured to swivel the first swivel flange about a first swivel axis; and
a supply device associated with the first lifting column, the supply device comprising at least one rechargeable storage device, fixed to the turning stand, configured to supply the first lift actuator and/or the first swivel actuator with electrical energy.

2. The turning stand according to claim 1, further comprising a component receptacle fastened to the first swivel flange and/or a further swivel flange.

3. A turning stand for handling, components, the turning stand comprising:
a first lifting column;
a first swivel flange arranged on the first lifting column;
a first lift actuator configured to adjust a height of the first swivel flange along a first lifting axis;
a first swivel actuator configured to swivel the first swivel flange about a first swivel axis;
a supply device, associated with the first lifting column, configured to supply the first lift actuator and/or the first swivel actuator with electrical energy,
a second lifting column;
a second swivel flange configured to swivel about a second swivel axis; and
a second lift actuator configured to adjust a height of the second swivel flange along a second lifting axis,
wherein the second lifting column includes a second swivel actuator configured to swivel the second swivel flange about the second swivel axis, and
wherein the first lifting column and the second lifting column are connected and/or connectable to one another by at least one carrier, and
wherein (i) the second lift actuator and/or the second swivel actuator are connected and/or connectable, via the at least one carrier,
to the supply device of the first lifting column, or (ii) the second lifting column has a second supply device configured to supply the second lift actuator and/or the second swivel actuator with electrical energy.

4. The turning stand according to claim 3, further comprising a component receptacle is fastened to the first and/or the second swivel flange.

5. The turning stand according to claim 3, wherein the first lift actuator is controlelectrically coupled to and/or mechanically decoupled from the second lift actuator, and/or the first swivel actuator is controlelectrically coupled to and/or mechanically decoupled from the second swivel actuator, and/or the first lift actuator is controlelectrically coupled to and/or mechanically decoupled from the first swivel actuator, and/or the second lift actuator is controlelectrically coupled to and/or mechanically decoupled from the first and/or the second swivel actuator.

6. The turning stand according to claim 3, wherein the supply device has at least one rechargeable storage device, fixed to the turning stand and configured to supply the electrical energy.

7. The turning stand according to claim 6, wherein the supply device has at least two rechargeable storage devices configured to alternatively supply electrical energy to the first and/or the second lift actuator and/or the first and/or the second swivel actuator.

8. The turning stand according to claim 3, wherein the first lifting column comprises a rail guide and/or a ball screw for adjusting a height of the first swivel flange along the first lifting axis, and/or wherein the second lifting column comprises a second rail guide and/or second ball screw for adjusting a height of the second swivel flange along the second lifting axis.

9. The turning stand according to claim 3, wherein the first swivel actuator has an angular gear for swiveling the first swivel flange about the first swivel axis, and/or wherein the second swivel actuator has as a second angular gear for swiveling the second swivel flange about the second swivel axis.

10. A turning stand module arrangement for producing the turning stand according to claim 1, the turning stand module arrangement comprising:
the first lifting column,
at least two different component receptacles for alternative connection to the first swivel flange of the first lifting column and/or at least one different further lifting column for alternative connection to the first lifting column and/or at least two different carriers for alternative connection of the first and a further lifting column.

11. A method for producing a turning stand using a turning stand module arrangement according to claim 10, the method comprising:
connecting the first lifting column to a component receptacle and/or, via at least one carrier, to a further lifting column, and
connecting at least one other, in particular structurally identical, different lifting column of the turning stand module arrangement is connected to a different component receptacle and/or to a further different lifting column and/or via a different carrier to a further lifting column.

12. A method for handling a component, the method comprising:
mounting the component on a first swivel flange by a component receptacle;
adjusting a height of the component mounted on the first swivel flange along a first lifting axis using a first lift actuator and/or swiveling the component mounted on the first swivel flange about a first swivel axis using a first swivel actuator; and
simultaneously and/or subsequently handling the component mounted on the first swivel flange.
